(19) United States
(12) Patent Application Publication
(10) Pub. No.: US 2026/0178788 A1
(43) Pub. Date: Jun. 25, 2026

(54) CONTEXT BASED DYNAMIC SWITCHING OF A MOBILITY MODE OF A TROLLEY ON A CONVEYOR RAIL

(71) Applicant: International Business Machines Corporation, Armonk, NY (US)

(72) Inventors: Sarbajit Kumar Rakshit, Kolkata (IN); Manikandan Padmanaban, Chennai (IN); Jagabondhu Hazra, Bangalore (IN)

(21) Appl. No.: 18/991,831

(22) Filed: Dec. 23, 2024

(51) Int. Cl. G06F 30/15; G06F 30/23; G06F 119/06; G06F 119/14; G06K 19/07

(52) U.S. Cl. CPC G06F 30/15; G06F 30/23; G06K 19/0723; G06F 2119/06; G06F 2119/14

(57) ABSTRACT

Dynamic switching of a mobility mode for trolleys on a conveyor rail involves obtaining a three-dimensional model of the rail and data on the payload and speed of each trolley. Aspects include simulating trolley movement to estimate vibrations on the rail and dynamically adjusting the mobility method to avoid resonance and optimize power consumption. Continuous monitoring and simulation of vibrations allow for real-time adjustments. Aspects utilize sensors and cameras to incorporate contextual factors such as rail vibrations, obstacles, and dust accumulation. The mobility method includes magnetic levitation and physical contact, with smooth transitions managed by controlling magnetic levitation force.

### BACKGROUND

The disclosure relates generally to conveyor systems and more specifically to dynamic switching of a mobility mode for trolleys on a conveyor rail.

Conveyor systems serve a function in various industries by enabling the movement of materials across different operational settings. These systems often face challenges related to resonance, which can result from design and operational parameters such as speed and payload. Resonance may cause materials to become dislodged, leading to potential damage and inefficiencies.

Environmental factors and the condition of the rail can further complicate operations. Dust accumulation and obstacles on the rail can lead to wear and tear on both the rail and the wheels of overhead trolleys. These issues contribute to operational inefficiencies, frequent maintenance, and potential downtime. Addressing these challenges requires a method that optimizes power consumption while preventing damage to the system.

### SUMMARY

According to one aspect of the present invention, a computer-implemented method for dynamic switching of a mobility mode for trolleys on a conveyor rail is provided. The method includes obtaining a three-dimensional model of the conveyor rail, obtaining a payload and a speed of each of a plurality of trolleys on the conveyor rail, and performing a simulation of movement of each of the plurality of trolleys on the conveyor rail to estimate generated vibrations on each section of the conveyor rail. The method also includes dynamically adjusting a mobility method for each of the plurality of trolleys for each section of the conveyor rail based at least in part on the simulation to avoid resonance and optimize power consumption and continuously monitoring and simulating vibrations on the conveyor rail and trolleys to dynamically adjust the mobility method of the trolleys.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to one or more embodiments;

FIG. 2 illustrates a block diagram of a trolley system and a control system for operating the trolley system, according to one or more embodiments;

FIG. 3A illustrates a trolley system facilitating dynamic switching of mobility modes for trolleys on a conveyor rail, according to one or more embodiments;

FIG. 3B illustrates a section of a conveyor system with a conveyor rail, trolleys, and rail supports, according to one or more embodiments; and

FIG. 4 illustrates a flowchart diagram of a method for dynamic switching of a mobility mode for trolleys on a conveyor rail, according to one or more embodiments.

The detailed description explains embodiments of the disclosure, together with advantages and features, by way of example with reference to the drawings.

### DETAILED DESCRIPTION

Conveyor systems play a role in various industries by facilitating the movement of materials across different operational settings. These systems often encounter challenges related to resonance, which can arise from design and operational parameters such as speed and payload. Resonance may lead to materials becoming dislodged, resulting in potential damage and inefficiencies. Additionally, environmental factors and the condition of the rail can further complicate operations. Dust accumulation and obstacles on the rail can cause wear and tear on both the rail and the wheels of overhead trolleys, contributing to operational inefficiencies, frequent maintenance, and potential downtime.

Existing solutions for managing conveyor systems often fail to address the dynamic nature of these challenges effectively. Traditional systems may rely solely on physical contact-based mobility, which can lead to increased friction and wear, especially in areas with obstacles or discontinuities. These systems may also lack the ability to adapt to varying conditions along the conveyor rail, resulting in suboptimal power consumption and increased maintenance requirements. Furthermore, the inability to dynamically adjust mobility modes can lead to resonance-induced damage, compromising the structural integrity of the conveyor system.

The present disclosure introduces a method and system for context-based dynamic switching between magnetic levitation and contact mobility of overhead trolleys on a conveyor rail. This approach aims to optimize power consumption while preventing damage to the conveyor ecosystem. By dynamically adjusting the mode of movement based on real-time data and simulations, the system can minimize vibrations and wear, ensuring efficient and reliable operation. The integration of sensors and cameras allows for continuous monitoring of rail conditions, enabling proactive adjustments to the mobility method to maintain optimal performance.

Dynamic switching between magnetic levitation and contact mobility of overhead trolleys on a conveyor rail offers significant benefits, including energy savings and an increased lifespan of the conveyor system. By intelligently alternating between these modes based on real-time conditions, the system optimizes power consumption, using magnetic levitation only when necessary to reduce friction and wear. This targeted use of energy not only conserves resources but also minimizes operational costs. Additionally, by reducing physical contact with the rail, the system decreases wear and tear on both the rail and the trolleys, extending their lifespan and reducing maintenance needs. This proactive approach ensures smoother operation, enhances efficiency, and contributes to the overall sustainability of the conveyor system.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

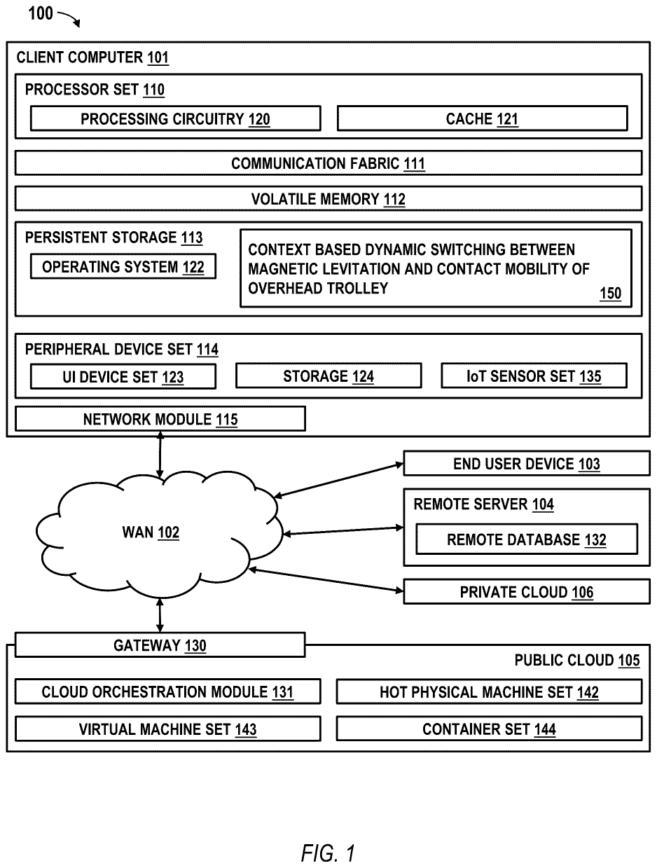

FIG. 1 illustrates a computing environment 100, according to an embodiment. Computing environment 100 contains an example of an environment for the execution of at least some of the computer code involved in performing the inventive methods, such as controlling the operations of a metal cutting tool, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide for remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

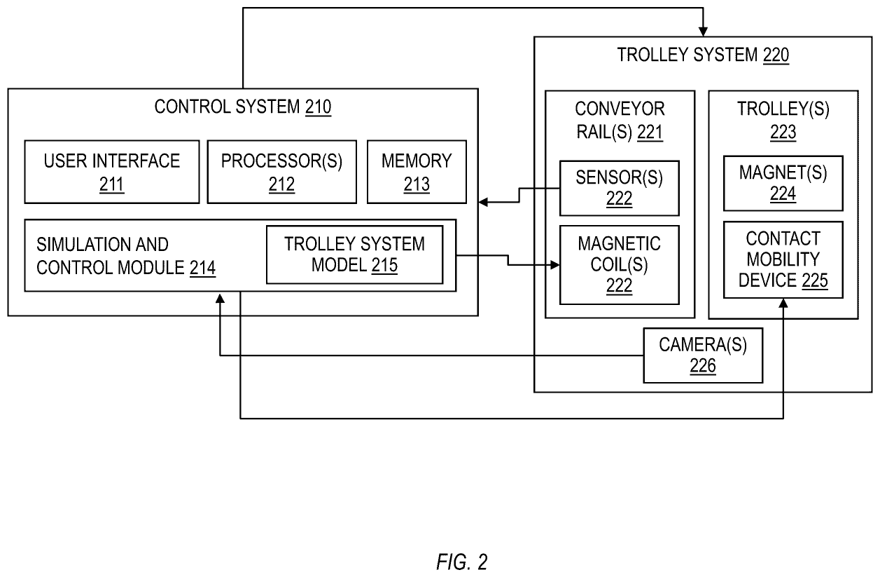

Referring now to FIG. 2, a block diagram of a trolley system 220 and a control system 210 for operating the trolley system 210 is shown. As illustrated, the control system 210 interfaces with the trolley system 220 to manage the dynamic switching of the mobility mode of the trolleys 223. In exemplary embodiments, each trolley 223 is configured to operate in one of a magnetic levitation mobility mode and a contact mobility mode.

In a magnetic levitation mobility mode, the trolley 223 are lifted above the conveyor rail 221 using magnetic forces. For example, magnetic coils 222 along the conveyor rail 221 generate a magnetic field that interacts with magnets 224 on the trolleys 223, creating a repulsive force that levitates the trolleys 223 above the conveyor rail 221. This mobility mode minimizes friction and wear, allowing for smoother and more efficient movement. The control system 210 can dynamically adjust the magnetic levitation force to maintain stability and optimize power consumption, ensuring that the trolleys hover at the desired height without contact with the rail. In the magnetic levitation mobility mode, propulsion is generated through the interaction of magnetic fields. The magnetic coils 222 along the conveyor rail 221 create a controlled magnetic field that interacts with magnets 224 on the trolleys 223. By adjusting the polarity and strength of these magnetic fields, a repulsive force is generated, which not only lifts the trolleys 223 but also propels them forward along the conveyor rail 221. The control system 210 can dynamically control the magnetic field to regulate speed and direction, allowing for precise and efficient movement without physical contact with the conveyor rail 221.

In the contact mobility mode, the trolleys 223 move along the conveyor rail 221 using wheels that maintain physical contact with the conveyor rail 221. This mobility mode is employed when magnetic levitation is not optimal, such as in areas with obstacles or discontinuities that require precise navigation. The wheels are designed to provide stability and control, allowing the trolleys to traverse the rail efficiently. The system continuously monitors the rail conditions and dynamically switches to contact mobility when necessary to ensure safe and reliable operation. In the contact mobility mode, propulsion is generated through the use of wheels that maintain physical contact with the conveyor rail. The wheels are driven by motors that provide the necessary force to move the trolleys along the rail. This mode allows for precise navigation, especially in areas with obstacles or discontinuities. The wheels are designed to offer stability and control, ensuring efficient traversal of the rail. The control system 210 continuously monitors rail conditions and adjusts the wheel speed and direction to maintain safe and reliable operation.

In exemplary embodiments, the control system 210 processes data from various sensors 222 and cameras 226 to identify contextual factors affecting the conveyor rail 221. The control system 210 includes the user interface 211, which allows operators to input parameters and receive feedback on system performance. The user interface 211 connects to processor(s) 212, which execute the control algorithms necessary for optimizing power consumption and minimizing vibrations.

In exemplary embodiments, processor(s) 212 perform computations required for the simulation and control module 214. In exemplary embodiments, the simulation and control module 214 conducts simulations to predict vibration patterns and determine optimal mobility strategies for the trolleys 223. The simulation and control module 214 utilizes data from the trolley system model 215, which represents the physical and operational characteristics of the trolley system 220. The trolley system model 215 aids in simulating various scenarios to avoid resonance and optimize power usage.

In exemplary embodiments, the trolley system 220 includes the conveyor rail 221, which supports the movement of trolley(s) 223. The conveyor rail 221 integrates sensor(s) 222 to detect vibrations and other environmental factors such as dust accumulation and obstacles on the conveyor rail 221. These sensors 222 provide real-time data to the control system 210, enabling dynamic adjustments to the trolley mobility method. The magnetic coil(s) 222 are strategically placed along the track to facilitate magnetic levitation and propulsion when required. These coils interact with magnet(s) 224 on the trolley(s) 223 to achieve levitation, reducing contact-based wear and tear.

In exemplary embodiments, the trolley(s) 223 are equipped with both magnet(s) 224 and contact mobility device 225. The magnet(s) 224 enable magnetic levitation, while the contact mobility device 225 allows for physical rolling on the track. The control system 210 dynamically switches between these modes based on the simulation results and real-time sensor data. Camera(s) 226 are positioned to provide visual feedback on the track condition, detecting any discontinuities or obstacles that may affect trolley movement. This visual data complements the sensor inputs, ensuring comprehensive monitoring of the conveyor system's operational environment.

In exemplary embodiments, trolley system model 215 is continuously updated using real-time data collected from sensors 222 and cameras 226. The sensors 222 provide information on vibrations, dust accumulation, and obstacles along the conveyor rail, while the cameras 226 offer visual feedback on track conditions and the observed movement of the trolleys 223. This data is fed into simulation and control module 214, allowing it to accurately update the trolley system model 215 to reflect the current operational environment of the trolley system 220. By integrating this real-time information, the trolley system model 215 can dynamically adjust to changes, ensuring that simulations and mobility strategies remain relevant and effective. This continuous updating process enables the control system 214 to optimize power consumption, minimize vibrations, and maintain efficient trolley operation, adapting swiftly to any variations in the conveyor system's conditions.

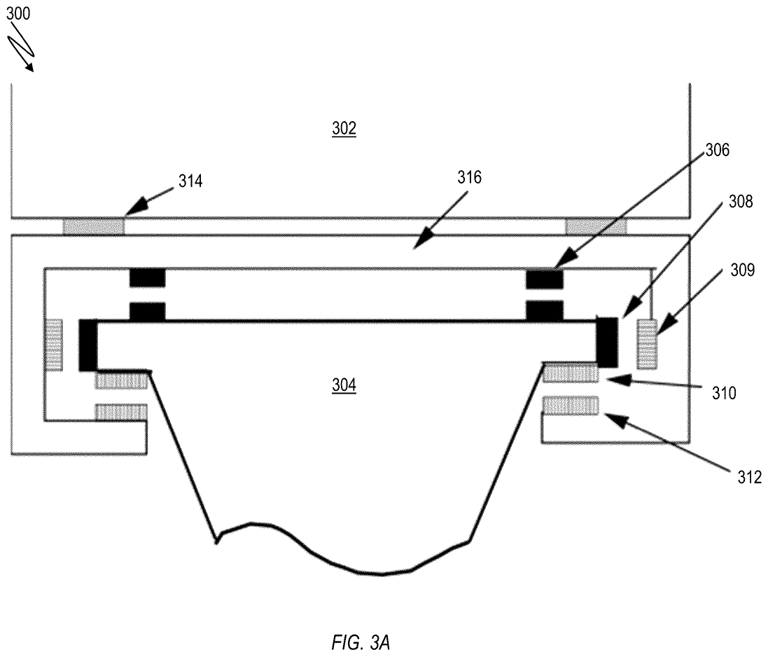

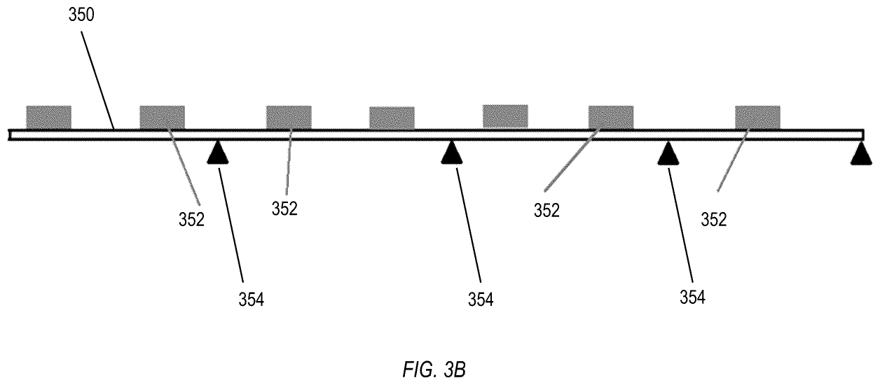

Referring now to FIG. 3A, a trolley system 300 in accordance with an embodiment is shown. As illustrated, the trolley system 300 includes a trolley 302, a guideway support structure 304, guideway skids 306, a guidance reaction rail 308, a guidance magnet 309, linear synchronous motor (LSM) stator & lift reaction rail 310, a lift magnet & LSM secondary 312, secondary suspension 314, and a magnet bogie 316. In exemplary embodiments, the trolley system 300 facilitates dynamic switching of mobility modes for trolleys 302 on a conveyor rail. The trolley 302 operates within trolley system 300, interacting with various components to enable movement along the conveyor rail. The trolley 302 is designed to switch between magnetic levitation and physical contact modes, depending on operational requirements.

In exemplary embodiments, the guideway support structure 304 provides structural support for the trolley system 300. The guideway support structure 304 ensures stability and alignment of the components, allowing for efficient operation of trolley 302. The guideway skids 306 are positioned to support the movement of Trolley 302. The guideway skids 306 facilitate smooth transitions between different mobility modes by providing a stable surface for physical contact. The guidance reaction rail 308 interacts with trolley 302 to guide the movement of trolley 302 along the rail. The guidance reaction rail 308 ensures precise navigation and alignment, contributing to the overall efficiency of the system. The guidance magnet 309 functions to ensure precise navigation and alignment of the trolley along the conveyor rail. The guidance magnet 309 interacts with the guidance reaction rail 308 to maintain the position of the trolley 302, providing stability and control during movement. This interaction helps the trolley follow the designated path accurately, minimizing deviations and enhancing the overall efficiency of the system. By maintaining proper alignment, the guidance magnet 309 contributes to smoother transitions between mobility modes and reduces the risk of operational disruptions. The LSM stator & lift reaction rail 310 is responsible for generating the magnetic field required for levitation. LSM stator & lift reaction rail 310 interacts with lift magnet & LSM secondary 312 to lift trolley 302 above the rail, minimizing friction and wear.

In exemplary embodiments, the lift magnet & LSM secondary 312 works in conjunction with LSM stator & lift reaction rail 310 to achieve magnetic levitation. lift magnet & LSM secondary 312 provides the necessary lift and propulsion forces, enabling the trolley 302 to move without physical contact. The secondary suspension 314 supports trolley 302, absorbing vibrations and ensuring stability during operation. The secondary suspension 314 contributes to the smooth operation of the system by minimizing disruptions caused by external factors. In exemplary embodiment, the magnet bogie 316 is integrated into trolley 302, housing the magnetic components necessary for levitation. Magnet bogie 316 interacts with LSM stator & lift reaction rail 310 and lift magnet & LSM secondary 312 to facilitate the dynamic switching of mobility modes.

Referring now to FIG. 3B, a section of a conveyor system having a conveyor rail 350, a series of trolleys 352, and rail supports 354 is shown. The conveyor rail 350 serves as the primary pathway for the trolleys 352, which are positioned along the rail. The rail supports 354 provide structural stability to the conveyor rail 350. The conveyor rail 350 is designed to facilitate the movement of the trolleys 352. The conveyor rail 350 provides a continuous track that guides the trolleys 352 along a predetermined path. The rail's construction allows for smooth transitions between different sections, accommodating the dynamic switching of mobility modes. The trolleys 352 are configured to operate on the conveyor rail 350. Each trolley 352 can switch between magnetic levitation and physical contact modes, depending on operational requirements. This flexibility enables the trolleys 352 to adapt to varying conditions along the conveyor rail 350, optimizing power consumption and minimizing wear. The rail supports 354 are strategically placed to maintain the alignment and stability of the conveyor rail 350. These supports ensure that the rail remains level and secure, preventing any deviations that could disrupt the movement of the trolleys 352. The design of the rail supports 354 contributes to the overall efficiency and reliability of the conveyor system.

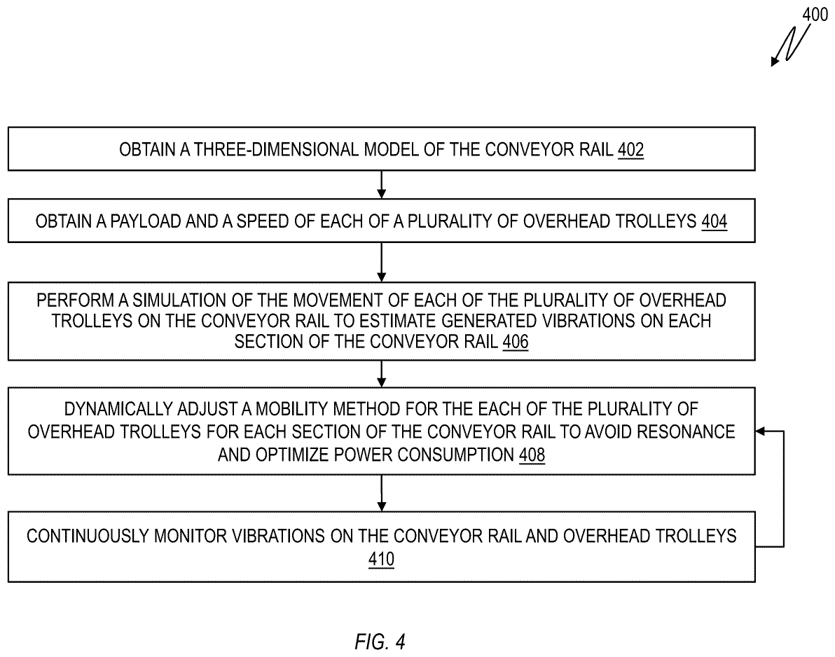

Referring now to FIG. 4, a flowchart diagram of a method 400 for dynamic switching of a mobility mode for trolleys on a conveyor rail is shown. In exemplary embodiments, the method 400 is performed by the control system 210 shown in FIG. 2. The method 400 begins at block 402 by obtaining a three-dimensional model of the conveyor rail. In exemplary embodiments, the three-dimensional model of the conveyor rail provides a comprehensive representation of the rail's physical structure and operational characteristics. This model includes detailed geometric data, capturing the rail's dimensions, curvature, and any structural features such as supports or joints. By incorporating these elements, the model accurately reflects the rail's physical layout, allowing for precise simulations of trolley movement. In exemplary embodiments, the three-dimensional model of the conveyor rail also integrates material properties, such as elasticity, density, and friction coefficients, which are used for predicting how the rail will respond to forces exerted by the trolleys. Additionally, the three-dimensional model of the conveyor rail may include contextual factors, which can affect the rail's performance. By simulating these conditions, the system can anticipate how the rail might behave under different scenarios, allowing for proactive adjustments to the trolley mobility method.

Next, as shown at block 404, the method 400 includes obtaining a payload and a speed of each of the plurality of trolleys. In exemplary embodiments, this step involves collecting data on the weight and velocity of each trolley, which is used for performing accurate simulations of the movement of the trolleys along the conveyor rail. In one embodiment, the payload information can be obtained using RFID tags for precise identification, ensuring that the control system has detailed knowledge of the load each trolley carries.

As shown at block 406, the method 400 also includes performing a simulation of movement of each of the plurality of overhead trolleys on the conveyor rail to estimate generated vibrations on each section of the conveyor rail. In exemplary embodiments, the simulation uses digital twin technology for enhanced simulation accuracy and applies finite element analysis for vibration prediction on the conveyor rail. By simulating the movement, the system can predict potential resonance and adjust the mobility method accordingly.

In exemplary embodiments, the control system employs digital twin technology to create a virtual replica of the conveyor system, allowing for enhanced simulation accuracy. This digital twin mirrors the physical characteristics and operational parameters of the actual system, enabling real-time analysis and prediction of system behavior. By integrating data from sensors and cameras, the digital twin continuously updates to reflect current conditions, such as payload variations and environmental factors. This dynamic model allows the system to simulate various scenarios, assessing how different mobility methods impact vibrations and power consumption. The digital twin provides a comprehensive platform for testing and optimizing the mobility strategy, ensuring that the system can adapt to changing conditions and maintain optimal performance.

In exemplary embodiments, finite element analysis (FEA) is applied within the digital twin framework to predict vibration patterns on the conveyor rail. FEA divides the rail into discrete elements, allowing for detailed examination of how forces and movements affect each section. By analyzing these elements, the system can identify potential resonance points and areas of stress concentration. This granular insight enables the system to adjust the mobility method of the overhead trolleys, switching between magnetic levitation and physical contact as needed to minimize vibrations and avoid resonance. The combination of digital twin technology and FEA ensures that the system can proactively manage vibrations, optimizing power consumption and reducing wear and tear on the conveyor components.

Consider a section of the conveyor rail where multiple trolleys are expected to pass simultaneously, each carrying varying payloads. Using finite element analysis within the digital twin framework, the conveyor rail is divided into discrete elements, each representing a small segment of the rail. Simulated forces are applied to the sections of the conveyor rail corresponding to the weight and speed of the, simulating their movement along the rail. By analyzing the response of each element, the system identifies areas where stress concentrations occur, indicating potential resonance points. For instance, if a particular segment shows increased deflection and stress under the simulated conditions, it may be prone to resonance.

In exemplary embodiments, when multiple trolleys move along the conveyor rail at different speeds, the forces they exert on the rail can interact in complex ways. Each trolley applies a force based on its weight and speed, creating vibrations in the rail. These vibrations can vary in frequency and amplitude depending on the trolley's characteristics and movement. As these forces combine, they can lead to constructive interference, where the vibrations from different trolleys align in phase, amplifying the overall vibration. This amplification can create stress concentrations in certain sections of the rail, leading to potential resonance points. Resonance occurs when the frequency of these combined vibrations matches the natural frequency of the rail, causing excessive oscillations. By simulating these conditions, the system can identify areas where resonance is likely to occur. This insight allows for adjustments in the mobility method, such as switching to magnetic levitation, to minimize vibrations and prevent resonance-induced damage. The ability to predict and manage these interactions ensures the conveyor system operates efficiently and reliably.

Next, as shown at block 408, the method 400 includes dynamically adjusting a mobility method for each of the plurality of overhead trolleys for each section of the conveyor rail to avoid resonance and optimize power consumption. In exemplary embodiments, the adjustment of the mobility method is based at least in part on the simulation results. In exemplary embodiments, the mobility method includes magnetic levitation and physical contact for the overhead trolleys with the conveyor rail. The system dynamically switches between these modes to ensure efficient operation, minimize energy usage, and minimize resonance vibrations of the trolley and/or the conveyor rail.

In one example, the simulation results indicate that a particular section of the conveyor rail has minimal obstacles and a stable surface. In this case, the control system may determine that maintaining magnetic levitation in this section is unnecessary and energy-intensive. By switching to physical contact mode, the trolleys can utilize wheels to traverse this section, reducing the energy required for levitation. This adjustment not only conserves power but also minimizes wear on the magnetic components, ensuring efficient operation. As the trolleys approach a section with potential resonance issues, the control system can dynamically switch back to magnetic levitation to minimize vibrations. This proactive adjustment, based on real-time data and simulation insights, allows the control system to optimize power consumption while maintaining stability and reducing the risk of resonance-induced damage. By continuously monitoring and adjusting the mobility method, the system ensures that energy usage is minimized without compromising operational efficiency.

In another example, the simulation predicts potential resonance in a section of the conveyor rail due to the combined weight and speed of multiple trolleys. In this example, the control system identifies that maintaining physical contact could amplify vibrations, leading to resonance and possible damage. To mitigate this, the control system dynamically switches the trolleys to magnetic levitation mode as they approach this section. By lifting the trolleys off the rail, the system significantly reduces the physical interaction and, consequently, the vibrations transmitted to the rail. This transition to magnetic levitation minimizes the risk of resonance, ensuring smoother operation and protecting the structural integrity of the conveyor system. The system continuously monitors the conditions and adjusts the mobility method as needed, maintaining optimal performance and reducing maintenance requirements.

In exemplary embodiments, the transition from physical contact to magnetic levitation is carefully managed to ensure smooth and seamless operation. As the trolleys approach a section where magnetic levitation is required, the system gradually increases the magnetic force. This gradual increase allows the trolleys to be gently lifted off the rail, avoiding any sudden jerks or instability. The control system continuously monitors the lift process, adjusting the magnetic field strength to maintain a steady and controlled elevation. Similarly, when transitioning back to physical contact, the magnetic force is gradually reduced, allowing the trolleys to gently settle onto the rail. This controlled approach ensures that the transition between mobility modes is smooth, minimizing wear on the components and maintaining operational efficiency.

Next, as shown at block 410, the method 400 includes continuously monitoring and simulating vibrations on the conveyor rail and overhead trolleys. In exemplary embodiments, the continuously monitoring and simulating allows the control system to dynamically adjust the mobility method of the overhead trolleys. This continuous monitoring ensures that any changes in the operational environment are quickly addressed, maintaining optimal performance.

In exemplary embodiments, the simulation also takes into consideration contextual factors of an environment of a conveyor rail that are obtained using one or more sensors and cameras. In exemplary embodiments, the sensors and cameras provide real-time data on the condition of the conveyor rail, including vibrations, broken sections, obstacles, and dust accumulation. This collected data is used for determining the appropriate mobility method for the trolleys on the conveyor rail.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for dynamic switching of a mobility mode for trolleys on a conveyor rail, the method comprising:
obtaining a three-dimensional model of the conveyor rail;
obtaining a payload and a speed of each of a plurality of trolleys on the conveyor rail;
performing a simulation of movement of each of the plurality of trolleys on the conveyor rail to estimate generated vibrations on each section of the conveyor rail;
dynamically adjusting a mobility method for the each of the plurality of trolleys for each section of the conveyor rail, based at least in part on the simulation, to avoid resonance and optimize power consumption; and
continuously monitoring and simulating vibrations on the conveyor rail and trolleys to dynamically adjust the mobility method of the trolleys.

2. The computer-implemented method of claim 1, wherein the simulation further includes contextual factors of an environment of the conveyor rail using one or more sensors and cameras, and wherein the contextual factors include vibrations on the conveyor rail, broken sections of the conveyor rail, obstacles on the conveyor rail, and dust accumulation on the conveyor rail.

3. The computer-implemented method of claim 1, wherein the mobility method includes one of magnetic levitation and physical contact.

4. The computer-implemented method of claim 1, wherein dynamically adjusting the mobility method includes controlling an increase or decrease of magnetic levitation force during transitions between physical contact and magnetic levitation to ensure smooth transitions without jerks.

5. The computer-implemented method of claim 1, wherein the payload of each trolley is obtained using RFID tags for precise identification.

6. The computer-implemented method of claim 1, wherein the simulation of movement uses digital twin technology for enhanced simulation accuracy.

7. The computer-implemented method of claim 1, wherein the simulation comprises applying finite element analysis for vibration prediction on the conveyor rail.

8. A system comprising:
a memory comprising computer readable instructions; and
a processing device for executing the computer readable instructions, the computer readable instructions controlling the processing device to perform operations comprising:
obtaining a three-dimensional model of a conveyor rail;
obtaining a payload and a speed of each of a plurality of trolleys on the conveyor rail;
performing a simulation of movement of each of the plurality of trolleys on the conveyor rail to estimate generated vibrations on each section of the conveyor rail;
dynamically adjusting a mobility method for the each of the plurality of trolleys for each section of the conveyor rail, based at least in part on the simulation, to avoid resonance and optimize power consumption; and
continuously monitoring and simulating vibrations on the conveyor rail and trolleys to dynamically adjust the mobility method of the trolleys.

9. The system of claim 8, wherein the simulation further includes contextual factors of an environment of the conveyor rail using one or more sensors and cameras, and wherein the contextual factors include vibrations on the conveyor rail, broken sections of the conveyor rail, obstacles on the conveyor rail, and dust accumulation on the conveyor rail.

10. The system of claim 8, wherein the mobility method includes one of magnetic levitation and physical contact.

11. The system of claim 8, wherein dynamically adjusting the mobility method includes controlling an increase or decrease of magnetic levitation force during transitions between physical contact and magnetic levitation to ensure smooth transitions without jerks.

12. The system of claim 8, wherein the payload of each trolley is obtained using RFID tags for precise identification.

13. The system of claim 8, wherein the simulation of movement uses digital twin technology for enhanced simulation accuracy.

14. The system of claim 8, wherein the simulation comprises applying finite element analysis for vibration prediction on the conveyor rail.

15. A computer program product for dynamic switching of a mobility mode for trolleys on a conveyor rail, the computer program product comprising:
a set of one or more computer-readable storage media;
program instructions, collectively stored in the set of one or more storage media, for causing a processor set to perform the following computer operations:
obtaining a three-dimensional model of the conveyor rail;
obtaining a payload and a speed of each of a plurality of trolleys on the conveyor rail;
performing a simulation of movement of each of the plurality of trolleys on the conveyor rail to estimate generated vibrations on each section of the conveyor rail;
dynamically adjusting a mobility method for the each of the plurality of trolleys for each section of the conveyor rail, based at least in part on the simulation, to avoid resonance and optimize power consumption; and
continuously monitoring and simulating vibrations on the conveyor rail and trolleys to dynamically adjust the mobility method of the trolleys.

16. The computer program product of claim 15, wherein the simulation further includes contextual factors of an environment of the conveyor rail using one or more sensors and cameras, and wherein the contextual factors include vibrations on the conveyor rail, broken sections of the conveyor rail, obstacles on the conveyor rail, and dust accumulation on the conveyor rail.

17. The computer program product of claim 15, wherein the mobility method includes one of magnetic levitation and physical contact.

18. The computer program product of claim 15, wherein dynamically adjusting the mobility method includes controlling an increase or decrease of magnetic levitation force during transitions between physical contact and magnetic levitation to ensure smooth transitions without jerks.

19. The computer program product of claim 15, wherein the payload of each trolley is obtained using RFID tags for precise identification.

20. The computer program product of claim 15, wherein the simulation of movement uses digital twin technology for enhanced simulation accuracy.
